(19) United States
(12) Patent Application Publication
(10) Pub. No.: US 2016/0055315 A1
(43) Pub. Date: Feb. 25, 2016

(54) DETECTION OF ABUSIVE PRESCRIBING OF CONTROLLED SUBSTANCES

(71) Applicant: Joseph W. Abbott, Boston, MA (US)

(72) Inventor: Joseph W. Abbott, Boston, MA (US)

(21) Appl. No.: 14/832,234

(22) Filed: Aug. 21, 2015

Related U.S. Application Data
(60) Provisional application No. 62/040,203, filed on Aug. 21, 2014.

(51) Int. Cl. G06F 19/00

(52) U.S. Cl. CPC G06F 19/3456

(57) ABSTRACT

An inappropriate prescription, prescriber, or prescribing location identification system and method for identifying inappropriate prescriptions, prescribers, or prescribing locations is disclosed.

### CROSS-REFERENCE TO RELATED APPLICATIONS

This application is a non-provisional of, and claims priority to and the benefit of, U.S. Provisional Patent Application No. 62/040,203, filed Aug. 21, 2014, the disclosure of which is hereby incorporated by reference herein in its entirety.

### FIELD OF THE DISCLOSURE

The disclosure relates generally to the field of prescription monitoring and particularly to detecting the abusive prescription of controlled substances.

### BACKGROUND OF THE DISCLOSURE

Public health advocates are increasingly focused on illness and deaths caused by the inappropriate use of controlled substances, such as, for example, opioid analgesics. Opioid prescriptions have increased dramatically in recent years: by more than 300% between 1999 and 2010. This increase has led to deleterious effects; the number of deaths due to overdose in the United States increased from 4000 in 1999 to 16,600 in 2010. Indeed, overdose is now the second-leading cause of accidental death in this country. Furthermore, more than 2.4 million people were considered opioid abusers in 2010. It is with respect to these and other considerations that the present disclosure is provided.

### BRIEF DESCRIPTION OF THE DRAWINGS

In the drawings, like reference characters generally refer to the same parts throughout the different views. In the following description, various embodiments of the present invention are described with reference to the following drawings, in which:

FIG. 1 illustrates a system for identifying an inappropriate prescriber of prescriptions in accordance with an embodiment of the present invention; and

FIG. 2 illustrates a method for identifying an inappropriate prescriber of prescriptions in accordance with an embodiment of the present invention.

### DETAILED DESCRIPTION

The present disclosure provides systems and methods for detecting potential abuse of prescriptions. In particular, the present disclosure provides a system and method for identifying the potential abuse of controlled-substance prescriptions.

As noted above, there has been an increase in the number of prescriptions granted for controlled substances, and, at least partially because of the increase, the abuse of controlled substances has increased. The causes of increases in prescriptions and the prevalence of abuse are manifold. In the mid-1990s, for example, advocates for treatment of chronic pain began arguing that pain was largely undertreated and appropriately exhorting clinicians to be more liberal in their treatment. In addition, a number of new formulations of opioid agents became available, with purported advantages in analgesia.

But perhaps just as importantly, inappropriate prescribing has grown. The worst form of such prescribing occurs in so-called “pill mills.” In a pillmill, fully licensed physicians with valid Drug Enforcement Administration (“DEA”) numbers write prescriptions that provide large quantities of powerful analgesics to individual patients. Some such pain clinics may cater to younger patients, operate on a cash basis, and draw clients from a broad geographic area. State governments and the DEA have attempted to curb these pill-mill activities with only limited success. The present disclosure, however, provides systems and methods whereby such activates may be identified at the pharmacist level.

Legally, pharmacies have a role to play in the oversight of prescriptions for controlled substances such as opioid analgesics. Under the Controlled Substances Act, for example, pharmacists must evaluate patients to ensure the appropriateness of any controlled-substance prescription. In addition, state boards of pharmacy regulate the distribution of opioid analgesics and other controlled substances through the discretion of pharmacists. Yet in the majority of cases of potential abuse, pharmacists face a patient who has a legal prescription from a licensed physician, and they have access to very little other background information. This limited access makes it difficult for individual pharmacists to use their own partially informed judgment to identify prescriptions that have come from a pill-mill doctor.

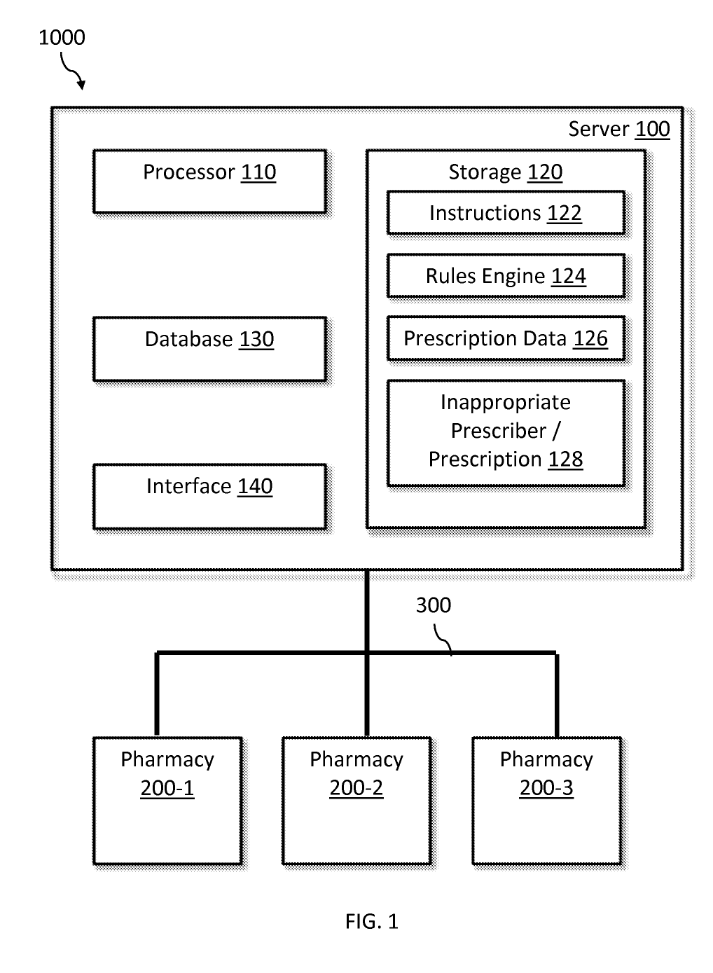

FIG. 1 illustrates a system 1000 in which a server 100 may aggregate information on some or all prescriptions filled at a number of different pharmacy locations. As depicted, a number of pharmacy locations 200-1, 200-2, 200-3 are operably connected to an inappropriate prescription detection server 100 through network 300.

The pharmacy locations 200-1, 200-2, and 200-3 may be each equipped with a computing device (which may include a processor, memory, and other components necessary to carry out the disclosure) to submit data related to the prescription of certain classes of medicines (e.g., opioids) to the server 100. The server 100 may then analyze the received prescription information and identify potentially inappropriate prescriptions, prescribers, and/or pharmacy locations. The server 100 may be used to detect inappropriate prescription in real time. More particularly, the locations 200 may submit prescription information while an associated prescription is being filled and/or at the time the patient (or doctor) requests the prescription be filled. As such, the server 100 may make a determination on the prescriptions before the corresponding medication is physically dispensed to the patient by the pharmacy. In some embodiments, the prescription data 126 is collected and repeatedly analyzed to detect suspicious behavior. When behavior is detected, the abusive/inappropriate prescriber and/or location 200 may be suspended and/or flagged for manual follow up or review.

The server 100 may be any of a variety of types of computing devices. For example, without limitation, the server 100 may be a server, a desktop computer, a cloud-computing system, or the like. As depicted, the server 100 and the locations 200-1, 200-2, and 200-3 exchange signals related to prescriptions (and other data) through a network 300.

In various examples, the network 300 may be a may be a single network possibly limited to or extending within a defined area, or other relatively limited area, a combination of connected networks possibly extending a considerable distance, and/or may include the Internet. Thus, the network 300 may be based on any of a variety (or combination) of communications technologies by which signals may be exchanged, including without limitation, wired technologies employing electrically and/or optically conductive cabling and wireless technologies employing radio frequency, near-field communication, infrared, or other forms of wireless transmission.

In various embodiments, the server 100 incorporates one or more of a processor component 110, storage 120, a database 130, and an interface 140 to couple the server 100 to the network 300. The storage 120 stores one or more instructions 122, rules 124, prescription data 126, and inappropriate prescribers/prescription data 128. The prescription data 126 may include aggregated prescription data 126 from multiple locations 200, possibly spanning multiple months, years, and may be stored in the memory 120, database 130, or any other storage device or system. During operation, the prescription data 126 may be transferred between the database 130 and storage 120 in order to facilitate identifying the inappropriate prescriber/prescription 128. Furthermore, although not depicted in FIG. 1, the database 130 may itself be stored in storage 120.

In the server 100, the instructions 122 may correspond to a sequence of instructions operative on the processor component 110 to implement logic to perform various functions. As discussed above, the server 100 is configured to communicate with multiple pharmacy locations 200. In general, the server 100 may be implemented to receive pharmacy data 126 and identify one or more inappropriate prescribers/prescriptions 128 from the pharmacy data 126. The server 100 may identify an inappropriate prescription individually and/or may identify an inappropriate prescriber. In one embodiment, when a prescriber is identified, prescriptions authorized by that prescriber are flagged as inappropriate.

In various embodiments, the processor component 110 includes any of a wide variety of commercially available processors. Further, one or more of these processor components may include multiple processors, a multi-threaded processor, a multi-core processor (whether the multiple cores coexist on the same or separate dies), and/or a multi-processor architecture of some other variety by which multiple physically separate processors are in some way linked.

In various embodiments, the storage 120 is based on any of a wide variety of information storage technologies, including volatile technologies requiring the uninterrupted provision of electric power and/or non-volatile technologies entailing the use of machine-readable storage media that may or may not be removable. Thus, each of these storages may include any of a wide variety of types (or combination of types) of storage device, including without limitation, read-only memory (ROM), random-access memory (RAM), dynamic RAM (DRAM), Double-Data-Rate DRAM (DDR-DRAM), synchronous DRAM (SDRAM), static RAM (SRAM), programmable ROM (PROM), erasable programmable ROM (EPROM), electrically erasable programmable ROM (EEPROM), flash memory, polymer memory (e.g., ferroelectric polymer memory), ovonic memory, phase change or ferroelectric memory, silicon-oxide-nitride-oxide-silicon (SONOS) memory, magnetic or optical cards, one or more individual ferromagnetic disk drives, or a plurality of storage devices organized into one or more arrays (e.g., multiple ferromagnetic disk drives organized into a Redundant Array of Independent Disks array, or RAID array). It should be noted that although each of these storage devices is depicted as a single block, one or more of these may include multiple storage devices that may be based on differing storage technologies. Thus, for example, one or more of each of these depicted storages may represent a combination of an optical drive or flash memory card reader by which programs and/or data may be stored and conveyed on some form of machine-readable storage media, a ferromagnetic disk drive to store programs and/or data locally for a relatively extended period, and one or more volatile solid state memory devices enabling relatively quick access to programs and/or data (e.g., SRAM or DRAM). It should also be noted that each of these storages may be made up of multiple storage components based on identical storage technology, but which may be maintained separately as a result of specialization in use (e.g., some DRAM devices employed as a main storage while other DRAM devices employed as a distinct frame buffer of a graphics controller).

In various embodiments, each of the interfaces 140 may employ any of a wide variety of signaling technologies enabling computing devices to be coupled to other devices as has been described. Each of these interfaces may include circuitry providing at least some of the requisite functionality to enable such coupling. However, each of these interfaces may also be at least partially implemented with sequences of instructions executed by corresponding ones of the processor components (e.g., to implement a protocol stack or other features). Where electrically and/or optically conductive cabling is employed, these interfaces may employ signaling and/or protocols conforming to any of a variety of industry standards, including without limitation, RS-232C, RS-422, USB, Ethernet (IEEE-802.3) or IEEE-1394. Where the use of wireless signal transmission is entailed, these interfaces may employ signaling and/or protocols conforming to any of a variety of industry standards.

In some examples, the server 100 may identify inappropriate (e.g., high-risk) behavior by benchmarking each prescriber represented in the prescription data 126 against each other on several parameters. In particular, in executing the instructions 122, the processor component 110 may receive prescription data 126 from one or more of the locations 200. This prescription data 126 may be aggregated and then characteristics of the prescription data 126 compared (e.g., by application of rules 124) across the system 1000 (e.g., across all perceptions, classes of prescriptions, or the like) to identify abusive or inappropriate prescribers, locations, and/or patients.

For example, Table 1 (shown below) lists a comparison of identified abusive prescribers (“outlier” prescribers) and non-outlier prescribers. The comparison represented in Table 1 is based on an example of data related to prescriptions submitted between March 2010 and January 2012 from various pharmacy locations. In particular, prescription data related to prescriptions for hydrocodone, oxycodone, alprazolam, methadone, and carisoprodol were analyzed and a comparison of prescribing habits for outlier prescribers versus non-outlier prescribers is represented in Table 1.

TABLE 1
Prescribing Habits of Outlier Prescribers

| | Average Monthly Doses of | | |
|---|---|---|---|
| | High-Risk Drugs Prescribed | | Number of |
| | Outlier | Non-Outlier | Outlier |
| Clinician Type/Specialty | Prescribers | Prescribers | Prescribers |
| Internal Medicine | 11,314 | 422 | 12 |
| Physical Medicine | 5,599 | 916 | 1 |
| Family Practice | 12,903 | 575 | 8 |
| General Practice | 24,502 | 462 | 2 |
| Psychiatry | 18,757 | 213 | 3 |
| Nurse Practitioner | 10,715 | 160 | 2 |
| Obstetrics and Gynecology | 11,096 | 110 | 3 |
| Physician Assistant | 5,211 | 116 | 1 |
| Pain Medicine | 8,811 | 3,813 | 1 |
| Sports Medicine | 7,025 | 387 | 1 |
| Pediatrics | 5,524 | 31 | 2 |
| Anesthesiology | 8,128 | 1,749 | 1 |

In some embodiments, the instructions 122 and rules 124 may cause prescribers in the same geographic region who had the same listed specialty to be compared (e.g., benchmarked) against each other. A first comparison may be based on the volume of prescriptions for high-risk drugs and the proportion of the prescriber's prescriptions that were for such drugs, as compared with the volume and proportion for others in the same specialty and region. In some embodiments, the thresholds for suspicion are set at the 98^{th} percentile for volume and the 95^{th} percentile for the proportion. These thresholds were used in the example in Table 1; any thresholds, however, are within the scope of the present invention.

Prescribers may further or instead be evaluated with regard to the number of their patients who paid cash for high-risk drug prescriptions and/or the percentage of their patients receiving high-risk drugs who were 18 to 35 years of age. In both cases, the thresholds for suspicion may be set at the 90^{th} percentile among clinicians in the same region and specialty. Finally, the prescriptions for non-controlled substances with the prescriptions for controlled substances within the prescriber's practice on the same parameters may be compared.

Based on these comparisons, “outliers”—prescribers whose behavior and prescribing practice do not fit within the normal prescribing practice of their peers as identified by the sever 200—were identified. The prescription authorization for these identified prescribers may be suspended based on the identification.

In some embodiments, to decrease or minimize the possibility of suspending dispensing privileges for clinicians who were appropriately treating patients, the identified physicians may be interviewed or flagged for manual follow up or review prior to suspending the prescriber and/or locations authorization.

As can be seen from Table 1, in this example, 42 outliers were identified from nearly one million prescribers represented in the prescription data 126 used in this example.

As illustrated by the example discussed in conjunction with Table 1, inappropriate prescribers/prescriptions 128 may be identified based on applying rules 124 to prescription data 126. In particular, rules 124 may specify various areas or characteristics wherein prescribers, prescriptions, and/or dispensing locations 200 are to be compared to each other. The rules 124 may also specify the threshold levels where outliers or “abusers” are identified. Furthermore, the prescription data 126 may include indications and/or information for the areas where comparisons are to be made. More specifically, the data 126 may include indications of the metrics, characteristics, or details about the prescriptions, prescribers, locations, or the like to enable the server 100 to analyze the prescriptions and apply the rules 124 to them to identify outlier prescribers/locations/prescriptions, or the like. Furthermore, these comparisons may be made across locations 200, across prescribers within the system 1000, and/or across patients within the system 1000 to identify abusive locations, prescribers, and/or patients.

In some examples, the rules 124 may specify that volume be compared. For example, average monthly dosage-unit volume may be compared across the months that a prescriber has any positive prescribing. This monthly average may then be compared to other prescribers within a region and/or within a specialty. As another example, average monthly dosage-unit volume is calculated across the months that a location has any positive prescribing. This monthly average may then be compared to other locations within a geographic area. This average may also be adjusted based on total volume for the store.

In some examples, the rules 124 may specify that a “share” of high-risk drugs to all drugs prescribed be compared. For example, a locations share may be derived as the drug of interest volume divided by total prescription volume (e.g., in dosage units). In other embodiments, a prescriber's drug share may be derived as high-risk drug volume divided by total prescription volume (e.g., in dosage units). These shares may then be compared to other prescribers within the region and within the specialty.

In some embodiments, the rules 124 specify that a number of “frequent-filling” patients be compared. Frequent-filling patients may be defined as patients who fill a certain number (e.g., two) or more short-days-supply prescriptions (<30 days) or 30-day-supply prescriptions during a time period, such as one or six months. For example, the share of drug-of-interest prescriptions at the location filled by patients who frequent fills may be compared. As another example, the share of high-risk drug filling patients who frequent fill are compared. If a patient has one month where he/she has a frequent fill, then that patient may be considered a frequent fill patient for the entire period. The number of frequent filling patients per prescriber may be compared against other prescribers.

In some examples, rules 124 may specify that “cocktail” prescriptions be compared. In particular, the percent of high-risk (e.g., oxycodone, or the like) prescriptions dispensed to patients also filling a prescription for another high-risk drug (e.g., methadone, a benzodiazepine, a muscle relaxant, a stimulant, or the like) on the same day may be compared. Cocktail drugs can be the same for hydrocodone prescriptions. In an opioid algorithm, methadone may not be considered to be a cocktail drug. In a benzodiazepine algorithm, any opioid may be considered a cocktail drug. The percentage of “cocktail” prescriptions written and/or filled may be compared.

In some embodiments, the rules 124 specify that the number of cash patients be compared. For example, the percentage of patients who paid for the drug-of interest in cash may be compared (e.g., between locations, prescribers, and/or the like). In some embodiments, the share of prescriptions for the drug of interest paid for in cash less the share of non-controlled drug prescriptions paid for in cash may be compared. Non-controlled may be defined as patients who have never been prescribed the drug at issue. For those patients, non-controlled prescriptions are considered.

In some embodiments, the rules 124 specify that the age of patients be compared. For example, the share of prescriptions for drugs of interest that are made to patients between the ages of 18-35 may be compared. In some examples, the relative age of patients may be compared. More particularly, the share of prescriptions for drug(s) of interest to patients aged 18-35 in excess of a non-controlled group. Non-controlled can be defined as patients who have never been prescribed the drug at issue. For those patients, non-controlled prescriptions are considered.

In some embodiments, the rules 124 specify that a distance be compared. For example, the share of prescriptions for the drug(s) of interest to patients greater than 20 miles from the pharmacy less the share of non-controlled drug prescriptions to patients greater than 20 miles from the pharmacy may be compared. Non-controlled can be defined as patients who have never been prescribed the drug at issue. For those patients, non-controlled prescriptions are considered.

In some examples, rules 124 specify that a growth in prescriptions be compared. For example, the percent growth in the drug(s) of interest prescriptions versus the percent growth in non-controlled prescriptions (e.g., most recent quarter to same quarter one year prior, or the like) may be compared.

In some examples, rules 124 specify that a percentage of only controlled substance prescriptions be compared. For example, the % of the drug(s) of interest prescriptions for patients who fill only controlled substances across the entire system 1000 within period (e.g., 6 months, or the like) may be compared.

In some examples, rules 124 specify that the number of patients filling at different locations be compared. For example, the % of the drug(s) of interest prescriptions for patients who fill such prescriptions at more than 2 locations 200 within a period (e.g., 6 months, or the like) may be compared.

In some examples, rules 124 specify that patients who mix payment methods (e.g., cash/insurance, or the like) be compared. For example, the % of the drug(s) of interest prescriptions for patients who have used cash for a high-risk drug (e.g., oxycodone Rx, or the like) and third-party insurance for another Rx within the same calendar month within a 6 month period. If a patient has done this in one month, then he/she can be considered a mixed insurance patient for the entire period.

In some examples, rules 124 specify that the average number of red flags (e.g., rule violations, above threshold comparisons, or the like) be compared. For example, the average of the number of potential red flags (all of the patient-level flags, cocktails, cash, age, distance, and doctor shopping, or the like) observed on a given prescription for the drug of interest can be compared across locations, prescribers, patients, or the like.

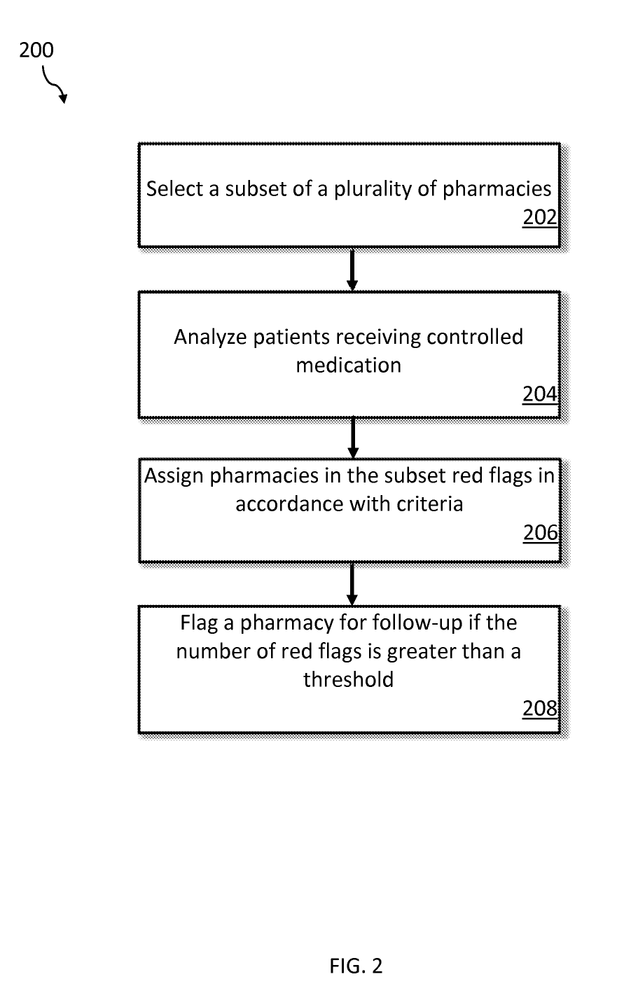

FIG. 2 illustrates a method 200 for identifying an inappropriate prescriber of prescriptions in accordance with embodiments of the present invention. A subset of a total number of pharmacies is selected (202); the selected pharmacies issue either a high volume or a high share (i.e., high percentage of total issued medications) of controlled medications. The high volume and high share may be selected based on a threshold (e.g., more than 1,000 controlled medications or more than 50% controlled medications issued per month) or relative to the other pharmacies (e.g., the top five issuers of controlled medications). In some embodiments, a pharmacy is selected if it is in the top 2% of volume or top 5% of share. Patients receiving controlled medications from the pharmacies are analyzed (204) using, for example, the rules and criteria listed herein. A pharmacy is assigned (206) a red flag if a percentile of patients receiving controlled medication meeting a criteria is greater than a threshold (e.g., higher than 95^{th}, 96^{th}, 97^{th}, 98^{th}, or 99^{th} percentile). In some embodiments, the red flag may be deemed to be justified or explained if similar patients do not meet the criteria for non-controlled substances. For example, a red flag may be initially assigned if a large number or percentage of patients pay in cash for controlled medication; if, however, a similar number or percentage of patients pay in cash for non-controlled medications at the same pharmacy, region, time of day, etc., then the red flag is not assigned because the behavior is common to the pharmacy or region and not necessarily different or distinct for controlled substances. In some embodiments, the red flag behavior is deemed unexplained if the relative patient threshold for any of cash, age, and distance is in the top 50%. If, however, a pharmacy is assigned a number of red flags greater than a threshold (e.g., five, ten, or fifteen), the pharmacy is flagged for follow-up. In some embodiments, a pharmacy is deemed to have disproportionate red flag behavior if either the absolute percentage of patients paying in cash or the absolute percentage of young (18-35) patients is in the top ten percent.

In some examples, prescription data 126 from a particular time period may be collected and aggregated in database 130. After which, new prescriptions data may be compared to identify inappropriate behavior. Said differently, database 130 may include a “history” or prescription data 126 for a specified time period against prescription data 126 for a subsequent time period may be compared.

In some examples, the cutoff value (e.g., threshold at which outliers are identified) may be determined based on behavior or patterns of behavior corresponding to prescribers who have been suspected by government, other pharmacies, or the like.

For example, applying rules 124 based on the comparisons shown in Table 2 for the set of prescription data from the pharmacy referenced above yielded the following results and identified potentially abusive prescribers.

TABLE 2
Results and Potentially Abusive Prescribers

| | | Prescriber 1 | Prescriber 2 | Prescriber 3 |
|---|---|---|---|---|
| | | (Emergency | (Internal | (Physical |
| | | Medicine) | Medicine) | Medicine) |
| High-Risk | Metric | 12,518 | 6,060 | 5,599 |
| Volume | (Percentile in | (99) | (98) | (98) |
| | excess of | | | |
| | specialty) | | | |
| High-Risk | Metric | 58% | 90% | 74% |
| Share | (Percentile in | (96) | (99) | (97) |
| | excess of | | | |
| | specialty) | | | |
| High-Risk | Metric | 3% | 32% | 13% |
| Cash | (Percentile) | (44) | (99) | (86) |
| High-Risk | Metric | 43% | 65% | 40% |
| Under 35 | (Percentile) | (92) | (98) | (91) |
| Cash in Excess | Metric | −2% | −68% | 10% |
| of Non- | (Percentile) | (23) | (100) | (88) |
| Controlled | | | | |
| Cash | | | | |
| Under 35 in | Metric | 9% | 65% | 34% |
| Excess of Non- | (Percentile) | (75) | (100) | (97) |
| Controlled | | | | |
| Under 35 | | | | |
| Travelling over | Metric | −1% | 31% | 0% |
| 30 Miles in | (Percentile) | (24) | (100) | (62) |
| Excess of Non- | | | | |
| Controlled | | | | |
| Travelling | | | | |

In some examples, the rules 124 may specify that prescription data be compared to identify abusive behavior in a multi-tiers approach. For example, the rules 124 may specify that inappropriate behavior is identified based on the following table.

TABLE 3
Tiers

| Volume and Share | Required number | Cutoff percentile of | |
|---|---|---|---|
| cutoff percentile | of red flags | red flags | Tier |
| Both at least in 99^{th} | 6 | 95 | Tier 1 |
| Both at least in 98^{th} | 7 | 95 | |
| Both at least in 97^{th} | 8 | 95 | |
| Both at least in 96^{th} | 9 | 95 | |
| Both at least in 95^{th} | 10 | 95 | |
| Both at least in 95^{th} | 5 | 95 | Tier 2 |

As reflected in Table 3, a multi-tiered approach may be implemented by rules 124 to identify inappropriate prescribers. It is important to note, that the cutoffs and counts of red flags used in the Table above may be adjusted to account for the number of prescribers in the prescription data 126 and an incomplete visibility into each individual prescriber's practice. Said differently, the above cutoffs and counts are given for illustration only and the actual cutoffs and counts used may be implementation dependent to result in the best balance between identifying abusive behavior and not suspending practitioners who are appropriately prescribing drugs of interest.

Table 3 shows that Tier 1 may correspond to prescribers identified with very high volume and extreme prescribing patterns that are highly irregular as compared to their “peers.” Prescribers classed into the first tier may be considered highly suspicions and may be flagged for suspension and/or automatically suspended.

Tier 2 may correspond to prescribers identified with high volume and several suspicious red flag metrics that are irregular as compared to their “peers,” but less so than Tier 1.

In some examples, different metrics may be selected for inclusion in rules 124 based on prior knowledge and/or study of existing system 1000 behavior or history. In some examples, the “counts” method reflected in Table 3 is more appropriate as it adjusts for unknown behavior or irregular behavior where specific targeted metrics may not be consistent between locations and/or prescribers for identifying abusive behavior. As such, abusive behavior may more accurately be predicted based on the tiers approach using red flag counts as outlined in Table 3.

In some examples, both volume and shares above cutoff of 95^{th} percentile may be required to identify a prescriber as abusive. Furthermore, the cutoff percentile may vary based on implementation (e.g., 85^{th}, 90^{th}, 95^{th}, 97^{th}, or the like).

An example comparison for one prescriber against other prescribers based on the tiers approach outlined in Table 4 is reflected below.

TABLE 4
Comparison Using Tiers

| Criteria | Metrics | Percentiles |
|---|---|---|
| Total six-month volume | 240 | |
| Average monthly volume | 40 | 98 |
| Mean volume for specialty | 1 | |
| in region | | |
| Share | 54% | 100% |
| Mean share for specialty in | 2% | |
| region | | |
| Cash share | 22% | 97 |
| 18-35-year-old share | 20% | 59 |
| Cocktail share | 4% | 43 |
| % patients who frequently | 28% | 78 |
| fill across all stores | | |
| % prescriptions filled by | 34% | 95 |
| patients only controlled | | |
| across all stores | | |
| % patients paying cash and | 37% | 99 |
| insurance in the same | | |
| month | | |
| % patients who have been | 0% | 33 |
| to three+ brand pharmacies | | |
| % patients who have been | 15% | 65 |
| to three+ of any pharmacy | | |
| Average red flags | 1.80 | 97 |
| % cash in excess of non- | 22% | 99 |
| controlled | | |
| % 18-35 in excess of non- | 20% | |
| controlled | | |
| % travelling 20+ miles in | −9% | |
| excess of non-controlled | | |

An example of the total prescribers identified as Tier 1 and Tier 2 from the example prescription data from the pharmacy referenced above is reflected in the table below.

TABLE 5
Summary of Tiers Results

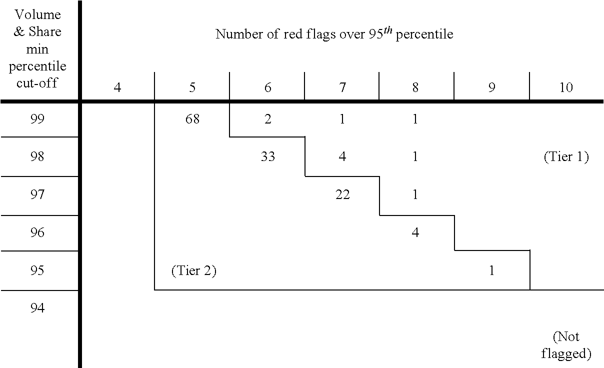

As can be seen from Table 5, 10 prescribers were identified in Tier 1 and 128 were identified in Tier 2.

In some examples, the server 200 may be configured to generate a report listing details and our information about the identified prescribers. For example, a report detailing the prescriber name, address, first and last prescription analyzed, specialty, metrics compared, or the like may be generated. This report may be communicated to locations 200, a central monitoring facility, government agencies, or the like in order to assist in the prevention of prescription abuse.

Thus, a prescription abuse identification system and method, in which inappropriate prescriptions, prescribers, and/or prescribing locations may be identified is disclosed.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

The various embodiments or components described above, for example, the server 100 and the locations 200 may be implemented as part of one or more computer systems. Such a computer system may include a computer, an input device, a display unit and an interface, for example, for accessing the Internet. The computer may include a microprocessor. The microprocessor may be connected to a communication bus. The computer may also include memories. The memories may include Random Access Memory (RAM) and Read Only Memory (ROM). The computer system further may include a storage device, which may be a hard disk drive or a removable storage drive such as a floppy disk drive, optical disk drive, and the like. The storage device may also be other similar means for loading computer programs or other instructions into the computer system. As used herein, the term ““module” or “software” software” includes any computer program stored in memory for execution by a computer, such memory including RAM memory, ROM memory, EPROM memory, EEPROM memory, and non-volatile RAM (NVRAM) memory. The above memory types are exemplary only, and are thus not limiting as to the types of memory usable for storage of a computer program.

While certain embodiments of the disclosure have been described herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is clamed is:

1. A system for identifying an inappropriate prescriber of prescriptions, the system comprising:
a network interface configured for receiving prescription data over a computer network from a plurality of pharmacies;
a non-volatile computer memory for storing the prescription data; and
a computer processor for executing software instructions to:
i. select, using the prescription data, a subset of the plurality of pharmacies issuing a high volume or high share of controlled medications;
ii. analyze patients receiving controlled medication via prescriptions submitted to the subset of the plurality of pharmacies against a set of criteria;
iii. assign a pharmacy in the subset of the plurality of pharmacies a red flag for each criteria in the set of criteria if:
a percentile of patients receiving controlled medication meeting a criteria is greater than a threshold percentile; and
a percentile of patients receiving non-controlled medication who meet the same criteria is less than a threshold percentile; and
iv. flag the pharmacy for follow-up communication if the number of red flags assigned thereto is greater than a threshold number.

2. The system of claim 1, wherein a pharmacy is selected to be in the subset of pharmacies if it is in the top two percent of volume of issuing controlled medications.

3. The system of claim 1, wherein a pharmacy is selected to be in the subset of pharmacies if it is in the top five percent of share of issuing controlled medications.

4. The system of claim 1, wherein a pharmacy is assigned a red flag if an absolute percentage of patients paying in cash for controlled medications is greater than ten percent.

5. The system of claim 1, wherein a pharmacy is assigned a red flag if an absolute percentage of patients receiving controlled medications who are ages 18-35 is greater than ten percent.

6. The system of claim 1, wherein a pharmacy is assigned a red flag if a relative percentile of patients receiving controlled medications is a 95^{th}, 96^{th}, 97^{th}, 98^{th}, or 99^{th} percentile.

7. The system of claim 4, wherein the pharmacy is not assigned the red flag if the percentile of patients receiving non-controlled medication is not in the top 50%.

8. The system of claim 1, wherein a pharmacy is assigned a first, high-risk tier if a number of assigned red flags exceeds a first red-flag threshold.

9. The system of claim 8, wherein a pharmacy is assigned a second, medium-risk tier if a number of assigned red flags is less than the first red-flag threshold but greater than a second red-flag threshold, wherein the first red-flag threshold is greater than the second red-flag threshold.

10. A method for identifying an inappropriate prescriber of prescriptions, the method comprising:
selecting, using prescription data received from a plurality of pharmacies and stored in a computer memory, a subset of the plurality of pharmacies issuing a high volume or high share of controlled medications;
analyzing patients receiving controlled medication via prescriptions submitted to the subset of the plurality of pharmacies against a set of criteria;
assigning a pharmacy in the subset of the plurality of pharmacies a red flag for each criteria in the set of criteria if:
i. a percentile of patients receiving controlled medication meeting a criteria is greater than a threshold percentile; and
ii. a percentile of patients receiving non-controlled medication who meet the same criteria is less than a threshold percentile; and
flagging the pharmacy for follow-up communication if the number of red flags assigned thereto is greater than a threshold number.

11. The method of claim 10, wherein a pharmacy is selected to be in the subset of pharmacies if it is in the top two percent of volume of issuing controlled medications.

12. The method of claim 10, wherein a pharmacy is selected to be in the subset of pharmacies if it is in the top five percent of share of issuing controlled medications.

13. The method of claim 10, wherein a pharmacy is assigned a red flag if an absolute percentage of patients paying in cash for controlled medications is greater than ten percent.

14. The method of claim 10, wherein a pharmacy is assigned a red flag if an absolute percentage of patients receiving controlled medications who are ages 18-35 is greater than ten percent.

15. The method of claim 10, wherein a pharmacy is assigned a red flag if a relative percentile of patients receiving controlled medications is a 95^{th}, 96^{th}, 97^{th}, 98^{th}, or 99^{th} percentile.

16. The method of claim 14, wherein the pharmacy is not assigned the red flag if the percentile of patients receiving non-controlled medication is not in the top 50%.

17. The method of claim 10, wherein a pharmacy is assigned a first, high-risk tier if a number of assigned red flags exceeds a first red-flag threshold.

18. The method of claim 17, wherein a pharmacy is assigned a second, medium-risk tier if a number of assigned red flags is less than the first red-flag threshold but greater than a second red-flag threshold, wherein the first red-flag threshold is greater than the second red-flag threshold.
